(19) United States
(12) Patent Application Publication
(10) Pub. No.: US 2020/0286136 A1
(43) Pub. Date: Sep. 10, 2020

(54) DIGITAL FEEDBACK AND REVIEW SYSTEM

(71) Applicants: Kanchan Khera, Gurgaon (IN); Gagandeep SINGH, Mohali (IN)

(72) Inventors: Kanchan Khera, Gurgaon (IN); Gagandeep SINGH, Mohali (IN)

(21) Appl. No.: 16/065,900

(22) PCT Filed: Dec. 30, 2016
(86) PCT No.: PCT/IB2016/058119

§ 371 Date: Jun. 25, 2018

(30) Foreign Application Priority Data
Dec. 31, 2015 (IN) 201611000605

(51) Int. Cl. G06Q 30/02; G06F 16/9536; G06F 16/9538

(52) U.S. Cl. CPC G06Q 30/0282; G06F 16/9538; G06F 16/9536

(57) ABSTRACT

The various embodiments herein disclose a tool for collection and collative representation of feedback and review from users pertaining to a product and/or service utilized by the users, the tool comprises a keyword module adapted to provide the user with one or more keywords representing parameters pertaining to the product and/or service and a rating module adapted to enable the user to provide attribute ratings corresponding to the one or more keywords. wherein the rating module is adapted to visually link each of the keywords to respective attribute ratings, thereby providing a single platform consolidated review to an end-user.

### BACKGROUND

### Technical Field of Invention

The present invention is generally related to data collection systems. More specifically, the present invention relates to a tool and method that can solicit, process and generate meaningful data from the feedback/reviews provided by the users of any product or service in an easy and convenient manner.

### DESCRIPTION OF RELATED ART

With advent of technology, people are using the internet more and more to share their experiences, such as of trips, a service used by them or a product purchased by them. First hand user experiences are considered as most reliable and as a result the service providers or product sellers also encourage end users to give their reviews so that any lapse in the service or product quality can be improved. Additionally, good product reviews help to enhance the reach of the product/service as more and more potential users would become interested to use the product/service on account of a good review. As per Forbes magazine, nearly 75% of online users are active on some or the other online platform and thus, such internet users invariably post their experiences of products/services purchased by them.

Currently, there are various channels of feedback/review that are available in the digital space these days. For instance, there are custom review applications/websites pertaining to each of the service providers that help them to take reviews of users of the products/services being provided by them. Besides, reviews are also obtained through paper based surveys or through telephone calls. In addition, users also use online social platforms like twitter, facebook and the like to post their unstructured reviews regarding their experiences. Also, there are innumerable bloggers who write biogs/articles with regard to their usage experience of different products/services.

However, all such existing feedback/review channels either capture overall feedback rating or are questionnaire based surveys followed by comment questions. The former approach of overall rating is typically used to get good response rate given the user would not spend more time. As such this feedback only provides high level picture and does not clearly talk about the pain points. In scenarios, where a proper questionnaire based survey is used with multiple questions, the user is reluctant to provide feedback given it asks lot more time from the user. Since such questionnaires are generally not suitable for small screens, like that of mobiles, adaptation to a small screen involves presenting the questions one by one, on subsequent screens, to the user. This is both cumbersome as well as time consuming for a user. As such people tend to avoid web based surveys and go for paper based surveys for capturing “in the moment” feedbacks. When the business does not provide immediate ways to capture feedback from customers, the users resort to social media tools or other open review platforms. These tools are risky as they do not provide opportunity to the business to take corrective action.

Each of these questionnaires are not standardized according to the industry/sector/product category. As such there is unavailability of a single platform which provides easy to fill, attribute based feedback, making it cumbersome for users to search for multiple products/services across the web. For example, a trainer would look for feedback on attributes like content, faculty knowledge, duration, value for money etc. vis-a-vis a service center would look for feedback on attributes such as service quality, time, cost, staff attitude etc.

In addition, these multiple feedback/review channels have the drawback that the reviews/feedbacks/blogs are present separately on different platforms and that too in formats. For instance, some service providers provide review platform seeking an overall rating as well as comments, if any, through a dialogue box. This results in unstructured reviews being generated as different users would write about different aspects, and may at times miss out on the important aspects of the product/service on which the product/service should be reviewed. Thus, for a user trying to browse through such unstructured reviews of a product/service prior to making a buying decision it becomes very cumbersome and difficult to analyze the true import of the review/feedback. Consequently, it is not convenient for a user to have a holistic view of the offers and product reviews across various platforms and make a well informed decision in a convenient and easy manner.

In view of the foregoing, there exists a need for a tool that obviates the various disadvantages of the conventional methods and systems, as discussed.

### OBJECT OF THE INVENTION

The primary object of the embodiments herein is to provide a tool that enables feedback collection in a quick and easy to use format and is device friendly. And, it still does not comprise on the attribute based feedback.

Another object of the embodiments herein is to provide a tool that enables generation of structured review related information that helps in standardization, helping the users and service providers to consume the information with maximum utility.

Yet another object of the embodiments herein is to provide an auto generated visual information about various attributes as disclosed by the user.

Yet another object of the embodiments herein is to provide a tool that can intelligently segregate the user input into meaningful data.

Yet another object of the embodiments herein is to provide a tool that is easy accessible from any device or hardware.

Yet another object of the embodiments herein is to provide a tool that significantly decreases the time of user feedback journey.

Yet another object of the embodiments herein is to provide a tool wherein it is easy to change and add the key attributes facilitating the better understanding about the product or service specified for review.

Yet another object of the embodiments herein is to provide a tool for providing a user with an integrated platform that enables him/her to provide easy to provide overall as well as attribute based reviews pertinent to a product/service/entity and also to an end-user to have a holistic view of the reviews provided by other users.

These and other objects and advantages of the embodiments herein will become readily apparent from the following detailed description taken in conjunction with the accompanying drawings.

### SUMMARY OF THE INVENTION

The present invention has been developed in response to the present state of the art, and in particular, in response to the problems and needs in the art that have not yet been fully solved by currently available techniques and processes. Accordingly, the present invention has been developed to provide an apparatus, system, and method for developing a single interface that overcomes many or all of the above-discussed shortcomings in the art.

The various embodiments herein disclose a tool for collection and collative representation of feedback and review from users pertaining to a product and/or service utilized by the users, the tool comprises a keyword module adapted to provide the user with one or more keywords representing parameters pertaining to the product and/or service and a rating module adapted to enable the user to provide attribute ratings corresponding to the one or more keywords, wherein the rating module is adapted to visually link each of the keywords to respective attribute ratings, thereby providing a single platform consolidated review to an end-user.

According to one embodiment herein, the attribute rating is represented by a numeric scale having a range of numeric values.

According to one embodiment herein, the attribute rating is represented by set of alphabetic scale, each value on scale representing a level of satisfaction experienced by the user for the attribute in consideration.

According to one embodiment herein, the attribute rating is represented by a set of visual indicators, each visual indicator representing a level of satisfaction experienced by the user for the attribute in consideration.

According to one embodiment herein, each keyword is visually represented on the scale at a position corresponding to the attribute rating provided by the user for the said keyword, thereby visually linking the each of the keywords to respective numeric ratings by either dragging the keyword to the rating to which they would like to rate or another way which offers a similar functionality to rate the keywords.

According to one embodiment herein, the keyword module is adapted to enable user to provide one or more keywords representing additional parameters, which the user is desirous of reviewing in respect of the product/service.

According to one embodiment herein, the rating module enables the end-user to retrieve review rendered by all users on a specific product/service in a desired graphical representation.

The embodiments herein provide a method for collection and collative representation of feedback and review from users pertaining to a product and/or service utilized by the users. The method comprises:

a) providing the user with one or more keywords representing parameters pertaining to the product and/or service;

b) receiving attribute ratings corresponding to the one or more keywords from the user by visually linking each of the keywords to respective attribute ratings, thereby providing a single platform consolidated review to an end-user.

According to one embodiment herein, the attribute rating is represented by a numeric scale having a range of numeric values.

According to one embodiment herein, the attribute rating is represented by set of alphabetic scale, each value on scale representing a level of satisfaction experienced by the user for the attribute in consideration.

According to one embodiment herein, the attribute rating is represented by a set of visual indicators, each visual indicator representing a level of satisfaction experienced by the user for the attribute in consideration.

According to one embodiment herein, the step of visually linking the keywords to attribute ratings comprises visually representing each keyword on the scale at a position corresponding to the attribute rating provided by the user for the said keyword.

According to one embodiment herein, the step of providing the user with one or more keywords comprises enabling user to provide one or more keywords representing additional parameters, which the user is desirous of reviewing in respect of the product/service.

According to one embodiment herein, the step of receiving attribute ratings corresponding to the one or more keywords comprises enabling the end-user to retrieve review rendered by all users on a specific product/service in a desired graphical representation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates an integrated tool in accordance with an embodiment of the invention.

FIG. 2 that illustrates a method for collection and collative representation of reviews from users.

FIGS. 3a, 3b & 3c illustrate the display effect of the integrated tool in accordance with an embodiment of the invention.

### DETAILED DESCRIPTION OF THE DRAWINGS

This invention disclosure describes the subject matter for patenting with specificity to meet statutory requirements. However, the description itself is not intended to limit the scope of this patent. The principles described herein may be embodied in many different forms.

Particularly, the present invention provides a tool that can be used across any type of industry to provide an integrated platform that enables reviews to be collected from users such that the reviews collected may be collated and presented to an end-user who may be a service provider, seller, manufacturer, a company or any other person seeking a quality response towards the product or a service delivered

In an embodiment herein, the user, i.e. the reviewer, as well as the review seeker, i.e. product/service provider, can create his own review module for a product or service under review. The said module is customizable to solicit reviews on selected parameters, representing attributes of the product/service to be reviewed, as required by the reviewer/review-seeker and presented to the end-users of the product/service so that actionable reviews are created for providing a holistic and structured review of the product/service under review. The tool is used to rate any attribute defined by the end user in respect of any product/service on pre-defined variable set. Such variable set may be a numeric scale, alphabetical scale or a visual indicator such as en ° icons. Each of the variable set represents a level of satisfaction experienced by the user for the attribute in consideration. The user visually links the attribute to the pre-defined variable set, as will be explained in the ensuing description.

Illustrative embodiments herein will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

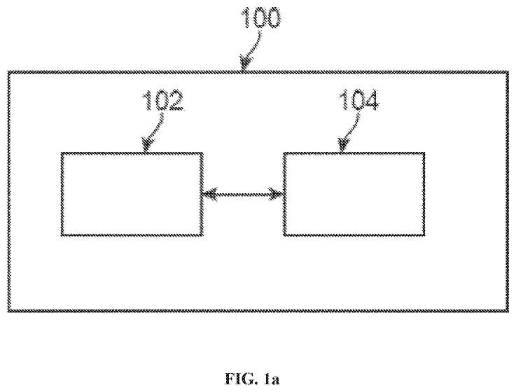

FIG. 1 illustrates an integrated tool 100 for collection and thereafter collative representation of feedback and review from users. The tool 100 may be software, hardware or a combination thereof embodied in a mobile smartphone, a personal digital assistant, a computer, and the like. In an embodiment of the present invention, the tool may be a software application.

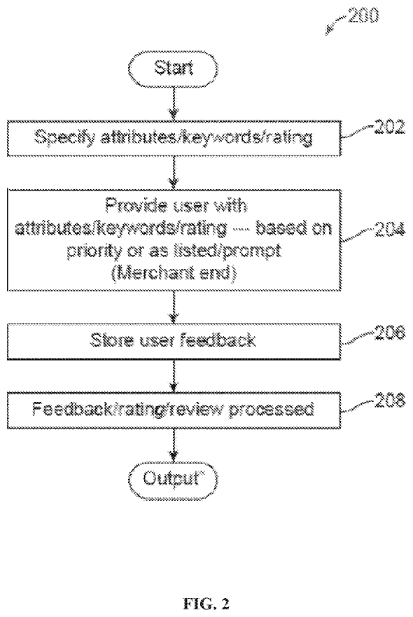

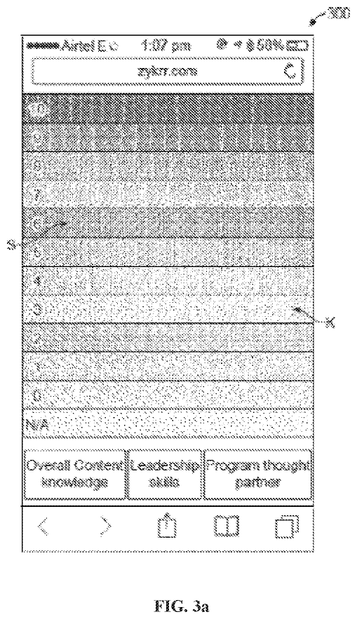

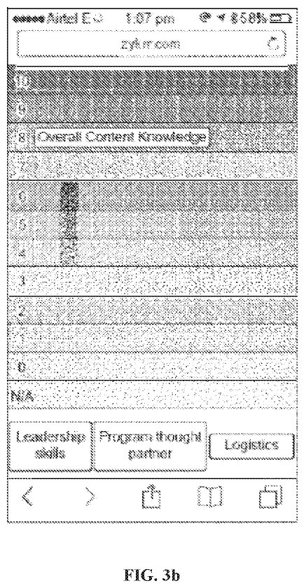

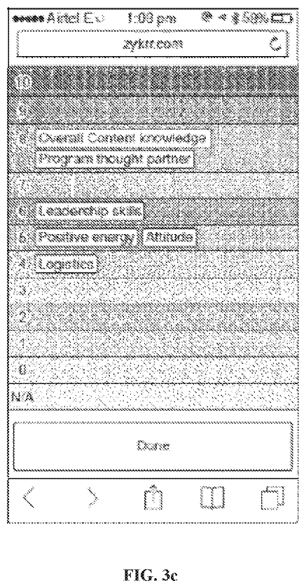

The tool 100 would be explained in conjunction with FIG. 1 that illustrates a block diagram of the tool 100 and FIGS. 3a to 3c that illustrate the features of the tool. The working of the tool would be explained with reference to FIG. 2 that illustrates a method 200 for collection and collative representation of reviews from users. As shown in FIG. 1, the tool 100 includes a keyword module 102. The keyword module 102 is adapted to present a user with one or more keywords. The keywords are representative of parameters in respect of a product and/or service/entity on which the feedback is solicited. The intention behind presenting the user with keywords is for the purpose of soliciting feedback from the user with regard to the specific parameters so that same may be made available to other users, for enabling them to make a wise decision. The keywords may be pre-determined by the provider of the service/product based on the type of product/service being offered by him/her. The present invention envisages that there may be additional attributes that the provider may not have thought of or considered as essential for his/her purpose, however, the reviewer might have specific comments regarding the said attributes. Therefore, the present invention provides that the keyword module 100 enables the user (reviewer) to add keywords representative of the additional attributes, while he/she is reviewing a product or service. In an embodiment, the reviewer may simply enter the additional keywords he/she wants to review and the same are created by the keyword module 102 for enabling the reviewer to provide his/her rating. In another embodiment, the end-user may specify the precedence level for each of the attributes (keywords) so that the reviews are shown to the end-user based on the priority level of each of the attributes, e.g. most important attributes first and lesser important ones later.

Further, to provide the user with the keywords, in an embodiment, the tool 100 renders an interface 300 (shown in FIG. 3a) to the user which includes one or more keywords ‘K’ represented on one of the x-y axis and a variable set represented on the other of the axes. The variable set is used to provide user's rating for each of the attributes. The present invention envisages that the variable set could include numeric scale, alphabetical scale or any other variable set having visual indicators such as emoticons scale. In the embodiment described herein, the visual set includes a numeric scale ‘S’ having numeric values. However, as stated earlier, the present invention should not be construed as limited to the numeric scale only and the visual set may include any of the options described hereinbefore. As an example, the business wants to understand the customer satisfaction for an iphone. The keywords chosen by mobile company may be for instance, size, weight, colours, functionality, performance, service quality, will recommend, worth etc. Typically, the attributes may be reviewed on number scale, alphabetical scale or any other variable set designating the customer review and feedback which help the end user or the company, to calculate the NPS score as well in the tool itself. In FIG. 3a, keywords are represented on the x-axis while the scale is represented on y-axis. The x-axis and y-axis is interchangeable based on the screen size available.

Further, as shown in FIG. 2, the tool 100 also includes a rating module 104. The rating module 104 is configured to enable the user to rate the attributes of a product on any given scale, as discussed in the preceding paragraphs. The present invention envisages that the user may be enabled to visually link the keywords (representing attributes of the product/service under review) one-by-one to desired rating scale. This will be explained in detail in conjunction with method of FIG. 2.

As shown in FIG. 2, the method commences at step 200 where the keyword module 102 of the tool 100 is adapted to present a user with one or more keywords. As shown in FIGS. 3a-3c, the s presented with an interface on which the keywords are represented on the x-axis while the rating scale is represented on y-axis. Further, at 204, the user may provide rating for each of the attributes of the product/service under review. As already explained, the rating scale could be numerical, alphabetical or any other variable set. Particularly, the described embodiment of the present invention envisages that the user may drag or click the keyword from the x-axis and places it onto the desired rating on the rating scale, as shown in FIG. 3b, The user performs the same steps for each of the keywords such that all keywords have been placed on respective ratings on the rating scale, as shown in FIG. 3c.

As it is evident, the claimed tool enables a single platform consolidated review wherein the respective ratings for all keywords are accessible. Thus, the tool 100 enables the users to provide feedback/review on different attributes pertaining to a product or service, thereby enabling the users to holistically review a product/service. Consequently, the end-user is presented with pertinent information on a single platform without requiring him/her in a structured and discernible format.

In this way the embodiments herein envisage that from the same platform it is enabled to access reviews/ratings of products/services in a structured format. The present invention is beneficial for both the product/service providers and users at the same time. The present invention enables product/service providers to be continually aware of user experience and feedbacks from a single platform without requiring them to access unstructured information available across different online platforms. This also helps to gauge early market/user responses at the time of new product launch. Moreover, it enables business players to know about the acceptability of a product/service on offer, and therefore the brand value, of a company which is being acquired or entered into joint venture. Besides, product/service providers can take strategic decisions since they are apprised of good and not so good experiences and have a clear visibility as to how the users are responding to their products/services on offer, and how they can improve the experience. Organizations, schools, hospitals, food joints aviation or any industry can right leverage this technology to get real-time attribute based feedbacks with real time analytics. Therefore, the integrated platform of the present invention serves the afore-said benefits which are missing from the existing state of the art.

In another preferred embodiment herein, the tool is adapted to collate reviews from different feedbacks by the user based on different attributes/parameters. In yet another embodiment of the present invention, the keywords may be optionally prompted based on the review writer's input words. Based on the first input the keywords may be prompted in preferential sequence as defined by end user or may be prompted as relevant. The tool disclosed herein provides an intelligent interface that may automatically add the most commonly used keywords by the review writer. In yet another embodiment, the reviews so gathered from users are stored and may be processed and represented in form of charts, bar diagrams or any other graphical representation. This is enabled by the rating module. The end user may be able to generate a performance based attributes sheet weekly, monthly or as desired by firing a pertinent query at the rating module.

In another embodiment herein, the end user may have a detailed informative data about the product listed. The tool disclosed herein is capable of segregating the reviews product wise, attribute wise and also month wise. It is needless to say that such processed data is helpful in improvising product or service by making the identification of the actual gap in the product or service quality.

Thus, the tool as envisaged enables an end-user to obtain and access reviews from users in a structured format that is easy to consume. Besides, the tool enables the user to add additional parameters based on which the product/service under review may be evaluated. As, the tool has considerably reduced the user feedback journey without impacting the quality of the review, the current invention is beneficial for both the reviewer and the end user.

Since other modifications and changes varied to fit particular operating requirements and environments are apparent to those skilled in the art, the invention is not considered limited to the example chosen for purposes of disclosure, and covers all changes and modifications which do not constitute departures from the true spirit and scope of this invention.

This written description uses examples to disclose the invention, including the best mode, and also to enable any person skilled in the art to practice the invention, including making and using any devices or systems and performing any incorporated methods. The above are merely exemplary and illustrative of the inventive concept by, one of ordinary skill in the art in the specific embodiments described to make various modifications or additions, or a similar alternative manner, without departing from the invention. The invention, as defined in this disclosure or beyond the scope of the claims, should belong to the scope of the present invention.

We claim:

1. A tool for collection and collative representation of feedback and review from users pertaining to a product and/or service utilized by the users, the tool comprising:
a keyword module adapted to provide the user with one or more keywords representing parameters pertaining to the product and/or service;
a rating module adapted to enable the user to provide attribute ratings corresponding to the one or more keywords;
wherein the rating module is adapted to visually link each of the keywords to respective attribute ratings, thereby providing a single platform consolidated review to an end-user.

2. The tool according to claim 1, wherein the attribute rating is represented by a numeric scale having a range of numeric values.

3. The tool according to claim 1, wherein the attribute rating is represented by set of alphabetic scale, each value on scale representing a level of satisfaction experienced by the user for the attribute in consideration.

4. The tool according to claim 1, wherein the attribute rating is represented by a set of visual indicators, each visual indicator representing a level of satisfaction experienced by the user for the attribute in consideration.

5. The tool according to claims 2 to 4, wherein each keyword is visually represented on the scale at a position corresponding to the attribute rating provided by the user for the said keyword, thereby visually linking the each of the keywords to respective numeric ratings by either dragging the keyword to the rating to which they would like to rate or another way which offers a similar functionality to rate the keywords.

6. The tool according to claim 1, wherein the keyword module is adapted to enable user to provide one or more keywords representing additional parameters, which the user is desirous of reviewing in respect of the product/service.

7. The tool according to claim 1, wherein the rating module enables the end-user to retrieve review rendered by all users on a specific product/service in a desired graphical representation.

8. A method for collection and collative representation of feedback and review from users pertaining to a product and/or service utilized by the users, the method comprising:
providing the user with one or more keywords representing parameters pertaining to the product and/or service;
receiving attribute ratings corresponding to the one or more keywords from the user by visually linking each of the keywords to respective attribute ratings, thereby providing a single platform consolidated review to an end-user.

9. The method according to claim 8, wherein the attribute rating is represented by a numeric scale having a range of numeric values.

10. The method according to claim 8, wherein the attribute rating is represented by set of alphabetic scale, each value on scale representing a level of satisfaction experienced by the user for the attribute in consideration.

11. The method according to claim 8, wherein the attribute rating is represented by a set of visual indicators, each visual indicator representing a level of satisfaction experienced by the user for the attribute in consideration.

12. The method according to claims 9 to 11, wherein the step of visually linking the keywords to attribute ratings comprises visually representing each keyword on the scale at a position corresponding to the attribute rating provided by the user for the said keyword.

13. The method according to claim 8, wherein the step of providing the user with one or more keywords comprises enabling user to provide one or more keywords representing additional parameters, which the user is desirous of reviewing in respect of the product/service.

14. The method according to claim 8, wherein the step of receiving attribute ratings corresponding to the one or more keywords comprises enabling the end-user to retrieve review rendered by all users on a specific product/service in a desired graphical representation.
